(19) United States
(12) Patent Application Publication
(10) Pub. No.: US 2016/0280039 A1
(43) Pub. Date: Sep. 29, 2016

(54) LIGHT DEVICE FOR VIEWING A CONTROL OF A FUNCTION

(71) Applicant: DAV, Creteil (FR)

(72) Inventor: Stéphane Vanhelle, Créteil (FR)

(73) Assignee: DAV, Créteil (FR)

(21) Appl. No.: 15/026,058

(22) PCT Filed: Sep. 30, 2014
(86) PCT No.: PCT/FR2014/000218

§ 371 Date: Mar. 30, 2016

(30) Foreign Application Priority Data
Sep. 30, 2013 (FR) 1302274

(51) Int. Cl. B60H 1/00; B60Q 3/02; H05B 33/08; B60Q 3/00

(52) U.S. Cl. CPC B60H 1/00564; B60Q 3/002; B60Q 3/0243; H05B 33/0845; H05B 33/0857

(57) ABSTRACT

The invention relates to a light device (20) for viewing a control of at least one function corresponding to at least one air flow entering the compartment of a motor vehicle, the light device comprising: at least one lighting source (22), and a device (24) for controlling said at least one lighting source, said control device (24) being designed so as to modulate the intensity and/or the colour of the light emitted by said at least one lighting source (22) according to the control of at least one function corresponding to at least one air flow entering the compartment of a motor vehicle.

The invention relates to a light device for viewing the control of at least one function relating to at least one air flow entering the passenger compartment of a motor vehicle.

Motor vehicles comprise an increasing number of various functions which the driver or passenger have to control. An example which may be mentioned is the control of a flow of hot or cold air entering the passenger compartment.

These functions may be controlled by controls in the form of buttons, touch-sensitive devices, gesture controls or even voice controls. However, it is still necessary to provide the user with information to assure him that his command has actually been executed.

This is particularly important when the user is the driver of the vehicle.

This command execution feedback is usually provided by a display on the control device, for example an indicator light on the control button, or by a display on a control screen.

These various types of display usually require the user to look at either the control button or the display device, so that he has to take his eyes off the road.

Consequently there is a need to provide a means of feeding back the information on the correct execution of his command to the user of a motor vehicle, which enables the user to receive this information in a simple and reliable way without having to take his eyes off the road.

For this purpose, according to a first aspect, the invention relates to a light device for viewing a control of at least one function relating to at least one air flow entering the passenger compartment of a motor vehicle, the light device comprising:

at least one light source,

and a control device of said at least one light source,

characterized in that
the control device is configured so as to modulate the intensity and/or the color of the light emitted by said at least one light source on the basis of the control of at least one function relating to at least one air flow entering the passenger compartment of a motor vehicle.

Advantageously, the light device according to the invention uses an illuminated indication of the correct execution of the command concerning the air flow, by modulating the intensity and/or the color of the light emitted by the light source.

Thus the lighting device according to the invention provides the user, in a simple, reliable and intuitive way, with the information concerning the correct execution of his command, without requiring the user to change the direction of his gaze.

The light device according to the invention is even more advantageous in that the control of the function is provided by voice recognition, by recognition of a user's gesture, or by any other contactless control means, requiring the provision of feedback to the user to inform him that his command has been executed.

The assembly according to the invention may also comprise one or more of the following characteristics, considered individually or in all technically feasible combinations:

the light source comprises one or more light-emitting diodes; and/or

the device further comprises a light guide intended to receive at least a part of the light emitted by the light source and to be positioned at an inlet through which the at least one incoming air flow enters the passenger compartment; and/or

the device comprises a plurality of light sources, the control device being configured to control each of the light sources independently; and/or

the control device comprises a correspondence table defining a correspondence between the control of said at least one function and the color and/or the intensity of the light emitted by the light source; and/or

the control relates to the orientation of the air flow; and/or

the control relates to the temperature of the air flow; and/or

the control relates to a fragrance present in the air flow; and/or

the control relates to the air conditioning of the passenger compartment.

The invention also relates to an instrument panel of a motor vehicle, comprising a device according to the invention.

The light source of the instrument panel according to the invention may be positioned, at least, at an inlet through which the at least one incoming air flow enters the passenger compartment.

The invention also relates to a method for controlling at least one light source intended to be incorporated into the interior of the passenger compartment of a motor vehicle, in the course of which the intensity and/or the color of the light emitted by said light source is modulated on the basis of the control of at least one function relating to at least one air flow entering the passenger compartment of a motor vehicle.

According to one embodiment, the control of the function is provided by means of gesture activation, with or without contact.

Finally, the invention relates to a control card capable of controlling the intensity and/or the color of at least one light source on the basis of the control of at least one function relating to at least one air flow entering the passenger compartment of a motor vehicle.

The invention will be more readily understood on consideration of the following description which is provided for guidance only and without limiting intent, accompanied by the appended drawings, in which:

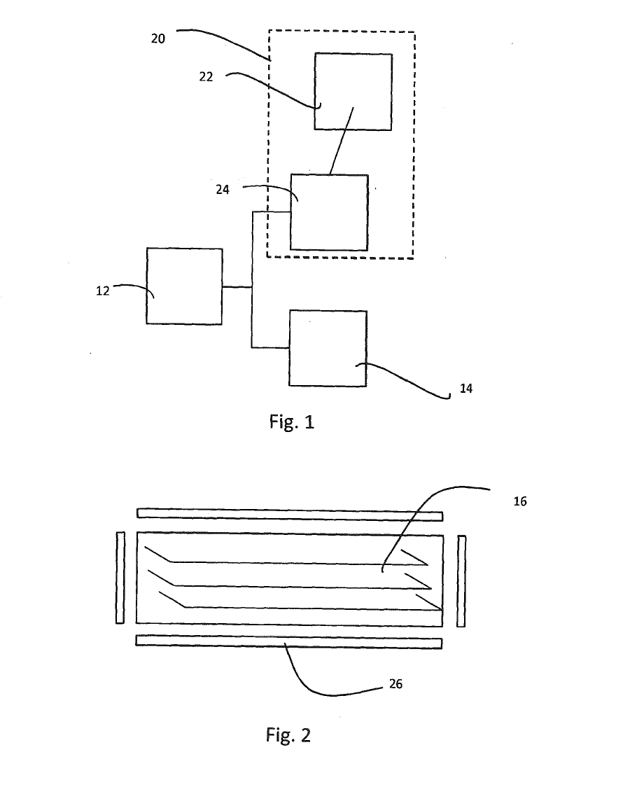

FIG. 1 shows in a schematic manner an assembly for controlling a function of an air flow, comprising a light device according to the invention,

FIG. 2 is a schematic view of an air flow inlet of a motor vehicle equipped with a lighting device according to the invention, and

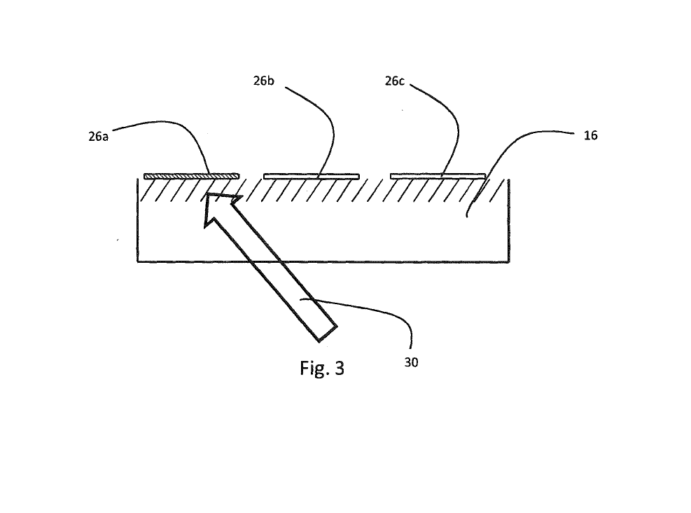

FIG. 3 is a schematic view of an air flow inlet allowing the orientation of said air flow in a motor vehicle equipped with a lighting device according to the invention.

As shown in FIG. 1, an assembly for controlling air flows in a motor vehicle comprises a control input element 12. The control input element sends the command to an air flow control device 14. According to the invention, a light device 20 is also connected to the control input element 12 in order to provide light information to the user about the execution of his command by the control input element.

The light device 20 according to the invention comprises at least one light source 22 and a control device 24 for the light source.

The control input element 12 enables the user, whether or not he is the driver of the motor vehicle, to control at least one function of the air flow in the passenger compartment of the motor vehicle without having to lower his gaze to the control buttons.

The control element 12 can be used to control:

the temperature of the air flow entering the motor vehicle and/or

the orientation of the air flow entering the motor vehicle and/or

the presence of one or more fragrances in the air flow entering the motor vehicle and/or

the choice of the fragrance or fragrances present in the air flow entering the motor vehicle and/or

the activation of the air conditioning in the passenger compartment.

The control element 12 may take the form of one or more buttons and/or touch-sensitive devices and/or gesture recognition devices, which, for example, use a camera and a calculation device for the recognition and interpretation of the hand gestures made by the user in the field of the camera. The control input element may also comprise a voice recognition device, enabling the user to control one or more functions of the air flow entering the passenger compartment by means of voice instructions.

The command received by the control input element 12 is interpreted and sent to the air flow control device 14. For example, if the command relates to an increase in the temperature of the air flow entering the passenger compartment of the motor vehicle, the air flow control device 14 activates heating means or reorients the air flow so as to increase the temperature of the air flow entering the passenger compartment.

The command received by the control input element 12 is also sent to the light device 20. The command is received by the control device 24. The control device 24 can control the light source 22 on the basis of one or more commands received by the control input element 12.

More particularly, the control device 24 can modulate the intensity and/or the color of the light emitted by the light source 22 on the basis of one or more commands received by the control input element 12.

According to one embodiment of the invention, the control device 24 comprises a correspondence table defining a correspondence between the command received by the control device and the color and/or the intensity of the light emitted by the light source.

For example, the command received by the control input element 12 may relate to the temperature of the air flow entering the passenger compartment of the motor vehicle. In this case, the correspondence table may cause the light source to emit a blue color when the commanded temperature is below the existing temperature of the air in the passenger compartment, and to emit a red color when the commanded temperature is above the existing temperature of the air in the passenger compartment. The intensity of the light emitted by the light source may be a function of the difference between the commanded temperature and the existing temperature of the air in the passenger compartment.

According to another example, the command received by the control input element 12 may relate to the choice of a fragrance of the air flow entering the passenger compartment of the motor vehicle. In this case, the correspondence table may provide associations between the available fragrances and colors of the light source. For example, there may be a green color for a mint scent, a red color for a strawberry scent, a yellow color for a lemon scent, and a white color for an absence of fragrance.

The intensity of the light emitted by the light source may be associated with the addition of fragrance to the air flow. The greater the addition of fragrance to the air flow, the more intense the illumination of the light source will be.

According to one embodiment, the control device may take the form of a control card capable of controlling the intensity and/or the color of one or more light sources on the basis of the command received by the control input element 12.

The lighting socket element according to the invention may comprise a number of light sources which may be controlled independently of one another by the control device.

According to one embodiment, the different light sources are positioned at different locations in the passenger compartment of the vehicle.

Advantageously, this may enhance the visual effect produced by the light device according to the invention.

A distribution of the different light sources may also enable the user to view the control of functions such as the orientation of the air flow.

For example, the device according to the invention may comprise light sources placed at each of the inlets through which an air flow can enter the passenger compartment. The command received by the control input element 12 may relate to the orientation of the air flow; for example, it may relate to the air flow inlet or inlets to be opened and the air flow inlet or inlets to be closed. The control device 24 can be used to control the light sources corresponding to the inlets whose opening has been commanded and the light sources corresponding to the inlets whose closure has been commanded. For example, the light sources corresponding to the inlets whose opening has been commanded are switched on or illuminated in a first color, and the light sources corresponding to the inlets whose closure has been commanded are switched off or illuminated in a color different from the first color.

According to one embodiment shown by way of example in FIG. 2, the light device according to the invention comprises at least one light guide 26 intended to receive at least a part of the light emitted by the light source or sources and to be positioned in the passenger compartment of the motor vehicle.

Advantageously, the light guide can enhance the visual impact of the light device with a smaller number of light sources.

In the example of FIG. 2, the light guide is positioned at an inlet 16 through which an air flow enters the passenger compartment. Advantageously, the positioning of the light guide at the air flow inlet can enhance the intelligibility of the visual signal supplied by the lighting device according to the invention.

As shown by way of example in FIG. 2, the light device according to the invention may comprise a number of light guides associated with different light sources and controlled, independently for example, by the control device 22.

As shown in FIG. 3, the various waveguides 26a, 26b, 26c may define areas at the inlet 16 of the air flow. The illumination of the different waveguides is controlled by the control device, for example on the basis of the command for orientation of the air flow 30 entering via said air flow inlet 16.

To reduce the overall dimensions and the power consumption, the light source or sources 22 advantageously comprise at least one light-emitting diode. The light-emitting diode or diodes may be replaced by an equivalent light source, of the OLED, AMOLED or FOLED type.

The invention also relates to an instrument panel of a motor vehicle comprising a light device according to the invention. According to one embodiment, at least one of the light sources is positioned at an inlet through which the at least one incoming air flow enters the passenger compartment.

The invention is not limited to the particular embodiments described above, and numerous variants may be devised without departure from the scope defined by the attached claims.

1. A light device for viewing the control of at least one function relating to at least one air flow entering the passenger compartment of a motor vehicle, the light device comprising:
at least one light source; and a control device of said at least one light source,
wherein the control device is configured so as to modulate the intensity and/or the color of the light emitted by said at least one light source on the basis of the control of at least one function relating to at least one air flow entering the passenger compartment of a motor vehicle.

2. The light device as claimed in claim 1, wherein the light source comprises one or more light-emitting diodes.

3. The light device as claimed in claim 1, further comprising a light guide intended to receive at least a part of the light emitted by the light source and to be positioned at an inlet through which the at least one incoming air flow enters the passenger compartment.

4. The light device as claimed in claim 1, further comprising a plurality of light sources, the control device being configured to control each of the light sources independently.

5. The light device as claimed in claim 1, wherein the control device comprises a correspondence table defining a correspondence between the control of said at least one function and the color and/or the intensity of the light emitted by the light source.

6. The light device as claimed in claim 1, wherein the control relates to the orientation of the air flow.

7. The light device as claimed in claim 1, wherein the control relates to the temperature of the air flow.

8. The light device as claimed in claim 1, wherein the control relates to a fragrance present in the air flow.

9. The light device as claimed in claim 1, wherein the control relates to the air conditioning of the passenger compartment.

10. An instrument panel of a motor vehicle comprising a light device as claimed in claim 1.

11. The instrument panel as claimed in claim 10, wherein the light source is positioned, at least, at an inlet through which the at least one incoming air flow enters the passenger compartment.

12. A method for controlling at least one light source intended to be incorporated into the interior of the passenger compartment of a motor vehicle, comprising:
modulating the intensity and/or the color of the light emitted by said light source on the basis of the control of at least one function relating to at least one air flow entering the passenger compartment of a motor vehicle.

13. The control method as claimed in claim 12, wherein the control of the function is provided by means of gesture activation, with or without contact.

14. A control card capable of controlling the intensity and/or the color of at least one light source on the basis of the control of at least one function relating to at least one air flow entering the passenger compartment of a motor vehicle.
